(19) United States
(12) Patent Application Publication
(10) Pub. No.: US 2025/0307746 A1
(43) Pub. Date: Oct. 2, 2025

(54) COMMUNICATION PROCESS FLOW PATH VARIATIONS

(71) Applicant: Salesforce, Inc., San Francisco, CA (US)

(72) Inventors: William Robert Jennings, II, Indianapolis, IN (US); Brian Robert Brechbuhl, Carmel, IN (US); Elisa Krebs, Lubbock, TX (US)

(21) Appl. No.: 19/029,786

(22) Filed: Jan. 17, 2025

Related U.S. Application Data
(60) Provisional application No. 63/571,649, filed on Mar. 29, 2024.

(51) Int. Cl. G06Q 10/0633; G06Q 30/0203

(52) U.S. Cl. CPC G06Q 10/0633; G06Q 30/0203

(57) ABSTRACT

A computing device of a data processing system may receive an indication from a user to create a communication process flow that includes a set of actions that control electronic communications between an entity and a set of users. The computing device may further receive one or more user inputs that indicate at least two first action variations of a first action of the set of actions and at least two second action variations of a second action of the set of actions. The system may then generate the communication process flow to include a set of paths for a set of combinations of the at least two first action variations and the at least two second action variations based on receiving the one or more user inputs. The system may then execute the communication process flow that includes the set of paths for the set of users.

### CROSS REFERENCE

The present Application for Patent claims priority to and the benefit of U.S. Patent Application No. 63/571,649 by Jennings et al., entitled “COMMUNICATION PROCESS FLOW PATH VARIATIONS,” filed Mar. 29, 2024, assigned to the assignee hereof, and is expressly incorporated by reference in its entirety herein.

### FIELD OF TECHNOLOGY

The present disclosure relates generally to database systems and data processing, and more specifically to communication process flow path variations.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a data processing system that supports communication process flow path variations in accordance with aspects of the present disclosure.

FIG. 2 shows an example of a computing system that supports communication process flow path variations in accordance with aspects of the present disclosure.

FIG. 3 shows an example of a path variation generation diagram that supports communication process flow path variations in accordance with aspects of the present disclosure.

FIG. 4 shows an example of a path variation testing diagram that supports communication process flow path variations in accordance with aspects of the present disclosure.

FIG. 5 shows an example of a variation process flow that supports communication process flow path variations in accordance with aspects of the present disclosure.

FIG. 6 shows an example of a process flow that supports communication process flow path variations in accordance with aspects of the present disclosure.

FIG. 7 shows a block diagram of an apparatus that supports communication process flow path variations in accordance with aspects of the present disclosure.

FIG. 8 shows a block diagram of a path variation generator that supports communication process flow path variations in accordance with aspects of the present disclosure.

FIG. 9 shows a diagram of a system including a device that supports communication process flow path variations in accordance with aspects of the present disclosure.

FIG. 10 shows a flowchart illustrating methods that support communication process flow path variations in accordance with aspects of the present disclosure.

### DETAILED DESCRIPTION

In some examples, users or administrators of a communication process flow management system may generate one or more communication process flows that include sets of actions to control communications between an entity (e.g., an organization of the user or the administrator) and a set of users. In some cases, the set of actions may include electronic communication messages (e.g., email messages), wait durations, follow-up messages, or any combination thereof. When generating a communication process flow, a user or administrator may generate a set of variations for one or more actions of the communication process flow. In some examples, when generating action variations, a user may determine to generate one or more paths for the different combinations of action variations. Further, in some cases, a user may generate a set of variations for two or more actions, thus increasing a quantity of action variation combinations for a path of the communication process flow. However, generating a respective path for each possible action variation combination of the communication process flow may be time-consuming and inefficient as a user would be expected to manually generate each path of the communication process flow.

To support the ability of a relatively large quantity of action variations to generate a relatively large quantity of paths, the techniques of the present disclosure may enable the use of one or more artificial intelligence (AI) or machine learning (ML) models (e.g., AI/ML models). For example, in response to receiving an indication of a creation of a communication process flow, a system (e.g., an application, a service, a server, a cloud-based system, or any combination thereof) may receive one or more user inputs indicating two or more variations for two or more actions of the communication process flow. The system may then utilize one or more AI/ML models to generate the communication process flow to include a set of paths for a set of combinations of the action variations. The system may then execute the set of paths of the communication process flow for a set of users. Additionally, or alternatively, the AI/ML models may be used to generate the action variations. Thus, the action variations may be generated by users, AI/ML models, or a combination thereof.

In some examples, each respective path for each action variation combination may include a respective combination of the set of combinations of the action variations. Further, the system may use AI/ML models to generate the set of paths for each possible combination of the action variations indicated by the user inputs. In some cases, the set of users may also be dynamically routed to respective paths based on the respective paths satisfying one or more performance metrics or one or more goals or automation events. An automation event may be a goal for a communication process flow that can be used to trigger one or more actions. Additionally, or alternatively, users may use the AI/ML models to suggest or generate additional paths to be implemented in the communication process flow based on the set of paths of the communication process flow, the one or more user inputs, or a combination thereof.

Aspects of the disclosure are initially described in the context of an environment supporting an on-demand database service. Additional aspects of the disclosure are described with reference to a computing system, a path variation generation diagram, path variation testing diagram, a variation process flow, and a process flow. Aspects of the disclosure are further illustrated by and described with reference to apparatus diagrams, system diagrams, and flowcharts that relate to communication process flow path variations.

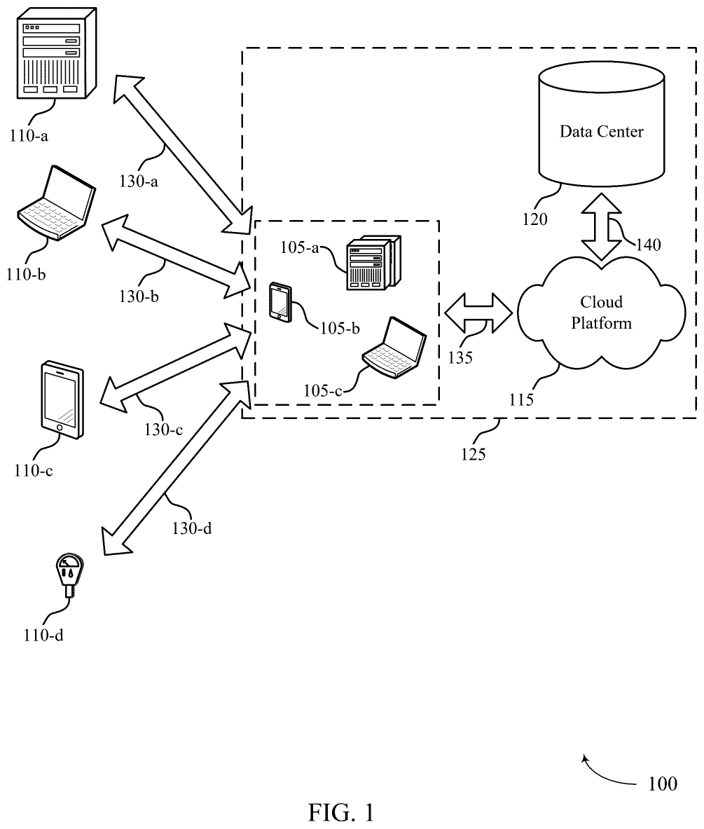

FIG. 1 illustrates an example of a system 100 for cloud computing that supports communication process flow path variations in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may support the generation of a communication process flow that includes a set of actions to control electronic communications between an entity (e.g., a tenant) and a set of users. For example, the communication process flow may control an organization or company transmitting a marketing campaign email to a set of users associated with the organization (e.g., users that purchase products from the organization). In some cases, a marketing user, or a set of marketing users of the organization may generate a set of variations for at least two actions of the communication process flow. For example, the marketing users may generate a set of variations of a subject line of an email that is transmitted to a set of users. In some cases, the marketing users may determine one or more wait durations before transmitting a follow-up email to respective users and a set of variations for the subject line of the follow-up email message. The user may then generate a first path and a second path for the communication process flow to determine whether a respective subject-line variation is relatively more effective than the others (e.g., based on satisfaction of an automation event or goal). However, some possible combinations of action variations may be omitted, thus resulting in inefficient and unreliable results from the communication process flow. Further, the system 100 may currently prevent a user from generating sets of variations for two or more actions of a communication process flow.

To provide relatively more efficient and reliable results, the techniques of the present disclosure may enable users the capability of creating variations for two or more actions of a communication process flow. For example, a user or a model (e.g., an AI/ML model) may generate two or more variations for a subject line of an email and two or more variations of a wait duration for transmitting a follow-up email. Further, the techniques of the present disclosure may describe the system 100 using AI/ML models to generate a path for the communication process flow for each possible combination of the action variations of the communication process flow. For example, a user may generate two variations of an initial email, two variations of a wait duration before transmitting a follow up email, and two variations of a follow-up email, and the system 100 may generate a set of paths for all possible action variation combinations (e.g., 8 combinations for the 3 actions with 2 variations each). Further, as the quantity of actions and the quantity of action variations increases, the ability for a user to manually generate a path for each possible combination may decrease as generating a relatively large quantity of paths may be relatively time-consuming and may be unsupported by the system 100. Therefore, in accordance with the techniques of the present disclosure, the system 100 may be enhanced to support automatically generating a set of paths for each possible action variation combinations.

Further, to determine the performance of respective paths in accordance with the techniques of the present disclosure, the system 100 may monitor the behavior of users routed through a set of paths to determine which paths are relatively more successful (e.g., satisfy a performance metric threshold, an automation event, or a goal more often). Based on such monitoring, the system 100 may use automation events for AI/ML models to dynamically allocate traffic to the relatively more successful paths. For example, an automation event of a respective path may be configured that if satisfied relatively more frequently, the automation event may trigger a weight to the respective path to be adjusted such that the AI/ML models can allocate relatively more traffic to the respective path. Moreover, the automation event may be used to train the AI/ML models. For example, as an automation event or goal of a respective path is satisfied (e.g., an expression indicated by a user equals a value of true or 1), the AI/ML models may be updated to understand that the respective path may be a successful path.

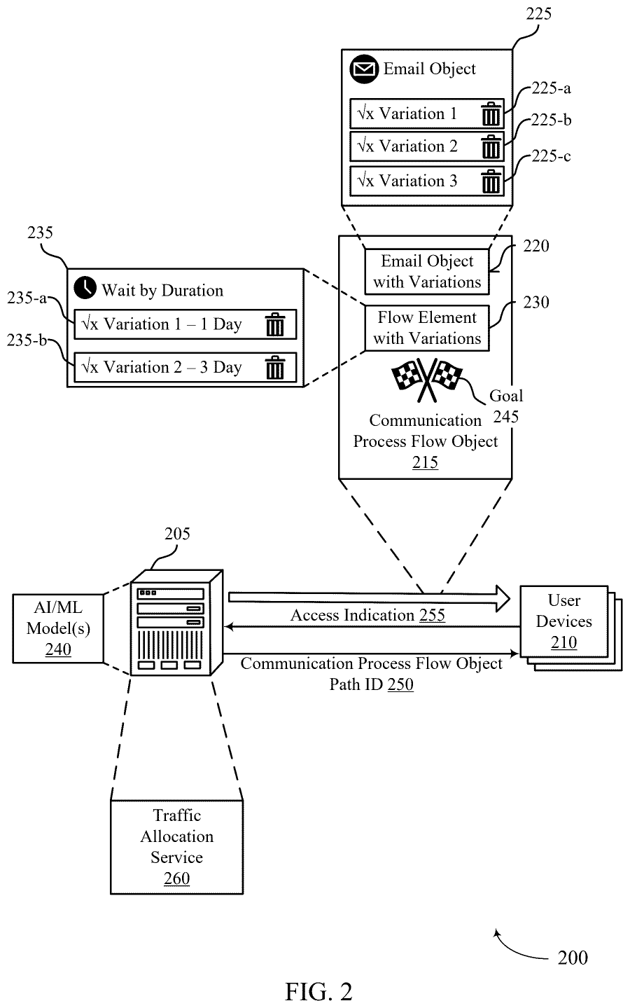

The techniques of the present disclosure may support a user generating a test for determining successful paths such that the system 100 can dynamically allocate, via automation events, the traffic over time to use a subset of paths. For example, if a respective path is relatively unsuccessful (e.g., rarely satisfies the performance metric threshold, the automation event, or the goal), the AI/ML models may learn and refrain from routing users to the respective path. Further, if a respective path is relatively successful, the AI/ML models may determine to increase the quantity of users being routed to the respective path. Moreover, such techniques of the present disclosure may provide a relatively more efficient and reliable process of allocating traffic between the set of paths of a communication process flow. For example, as the quantity of paths of the communication process flow increases, users may be unable to efficiently and reliably analyze the data to determine updated traffic allocations. Therefore, the techniques of the present disclosure may enable AI/ML models to automatically analyze performance data of the respective paths of the communication process flow to determine a more efficient and reliable traffic allocation pattern. Further descriptions of the techniques of the present disclosure may be described elsewhere herein, such as with reference to FIGS. 2-6.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 shows an example of a computing system 200 that supports communication process flow path variations in accordance with aspects of the present disclosure. In some examples, the computing system 200 may implement or be implemented by the system 100. For example, the computing system 200 may include a server 205 and one or more user devices 210 which may be examples of devices or services or may be implemented by devices or services described with reference to FIG. 1. For example, the server 205 and the one or more user device 210 may be examples of cloud clients 105 or contacts 110 described with reference to FIG. 1. Further, the computing system 200 may be a multi-tenant system or a part of a multi-tenant system such that a user may be associated with a respective tenant of the multi-tenant system.

In some examples, a user or administrative user may access a user interface supported by the server 205 to configure a communication process flow object 215 to control electronic communications between an entity and a set of users (e.g., a set of users associated with the one or more user devices 210). For example, the user may be an administrative user of an organization (e.g., a tenant of a multi-tenant system) that transmits marketing emails to users via the communication process flow object 215 and the user may generate one or more versions of the email and to compare the performance of the one or more versions. In some cases, the user may generate one or more paths of the communication process object 215 to experiment which email version may be more successful. In some examples, a path may be an example of a set of steps that the server 205 may perform for a respective user. For example, the user may manually generate a first path that initially transmits a first version of an email, waits 2 days for a response, and then sends a first version of a follow-up email and a second path that initially transmits a second version of the email, waits 3 days for a response, and then sends a second version of the follow-up email. However, such testing may omit some possible combinations of paths due to the user interface of the server 205 lacking an ability for a user to generate a relatively large set of paths and an ability to generate variations for each possible action of a communication process flow object 215.

To provide users the ability of enhancing the communication process flow object 215, the techniques of the present disclosure may enable the user the capability of adding variations of actions of the communication process flow object 215. In some examples, the actions of the communication process flow object 215 may also be referred to as objects or elements elsewhere herein. For example, the communication process flow object 215 may include an email object 220 that is associated with one or more email object variations 225 (e.g., an email object variation 225-a, an email object variation 225-b, an email object variation 225-c, or any combination thereof) generated by a user. In some cases, the one or more email object variations 225 may include separate content, subject lines, images, links, or any combination thereof. Further, a user may generate the one or more email object variations 225 for each separate variation. For example, the email object variation 225-a may be associated with a first subject line of an email and the email object variation 225-b may be associated with a second subject line of an email. Moreover, in some cases, users may use an AI/ML model 240 of the server 205 to generate different variations of portions of an email. In some examples, a generative AI model which may be an example of a type of AI/ML model 240 may be used to generate the email variations. Further, in some cases, users may use large language models (LLMs) to generate multiple different variations of a subject line based on the content of an email. LLMs may be an example of an AI/ML model 240 (e.g., a generative AI model) that can generate text from an input. Further, LLMs may be trained on relatively large corpuses of text data and are capable of processing relatively large amounts of data. Therefore, LLMs may be capable of responding to user queries. For example, a user may query an LLM to generate 5 different email subject line suggestions based on the body of an email that the user provides to the LLM. Thus, the computing system 200 may use LLMs to generate one or more email object variations 225.

Further, the communication process flow object 215 may include a flow element 230 that controls the flow or timing of transmitting messages (e.g., emails). In accordance with the techniques of the present disclosure users may be capable of generating one or more flow element variations 235 for the flow element 230 (e.g., a flow element variation 235-a, a flow element variation 235-b, or a combination thereof). In some cases, the one or more flow element variations 235 may represent different wait durations for sending a follow-up email to a respective user. For example, the flow element variation 235-a may indicate a wait duration of one day and the flow element variation 235-b may indicate a wait duration of three days. In some cases, the one or more flow element variations 235 may also be generated via LLMs. Additionally, or alternatively, the communication process flow object 215 may also include a goal 245 (e.g., automation event) to be used to determine if a path of the communication process flow object 215 is successful. In some cases, a goal 245 may also be referred to as an automation event as described elsewhere herein

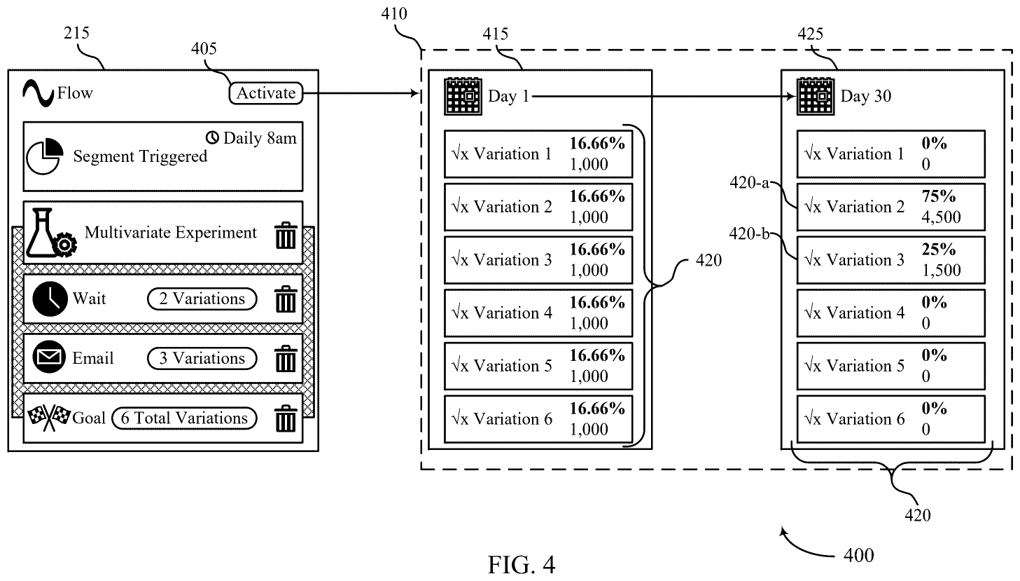

In some examples, users may generate two or more variations for each action of the communication process flow object 215. Therefore, a quantity of combinations of action variations of the communication process flow object 215 may be relatively large. Thus, to provide users the ability to generate a path for each possible combination of action variations, the server 205 may implement one or more AI/ML models 240 to manage the one or more action variations. For example, a user may use an AI/ML model 240 to generate a path for each possible combination of variations. Moreover, users may use the AI/ML models 240 to manage the traffic allocation of the paths of the communication process flow object 215. For example, if the communication process flow object 215 is associated with six different paths (e.g., six different combinations of the action variations), the AI/ML models 240 may manage how many users and which users are sent messages via the respective paths. In some examples, as described elsewhere herein such as with reference to FIG. 4, the AI/ML models 240 may route a set of users of the one or more user devices 210 to different paths of the communication process flow object 215 evenly. For example, for a set of six different paths of the communication process flow object 215 and a set of 300 users associated with 300 user devices 210, the server 205 may route subsets of 50 users to each respective path such that each is associated with an equal quantity of users. Routing users via a path may be such that server 205 may transmit electronic communications between an entity to a respective user in accordance with the steps and variations of a respective path of the communication process flow object 215. When transmitting emails via respective path, the server 205 may indicate a communication process flow object path identifier (ID) 250 such that the server 205 can determine which path of the communication process flow object 215 an email is associated with.

Moreover, during the execution of the communication process flow object 215, the AI/ML models 240 may monitor the performance of the one or more paths of the communication process flow object 215. For example, if a user that receives an email via a first path of the communication process flow object 215 opens the email, clicks on a link within the email, or performs one or more actions that satisfies the goal 245 (e.g., automation event), the server 205 may receive an access indication 255 from the respective user device 210. In some cases, the access indication 255 may also include the communication process flow object path ID 250 such that the server 205 can determine which path the access indication 255 is in accordance with. Further, a traffic allocation service 260 of the server 205 may use the access indication 255 to allocate the traffic of the users associated with the one or more user devices 210 to the paths of the communication process flow object 215. For example, as described herein, initially, the traffic allocation service 260 may distribute the messages for the set of users of the one or more user devices 210 equally across the paths of the communication process flow object 215. Further, based on monitoring the performance of the paths of the communication process flow object 215, the server 205 may determine, via the AI/ML models 240, that a subset of paths may be relatively more successful and the traffic allocation service 260 may begin to route more users to the subset of paths.

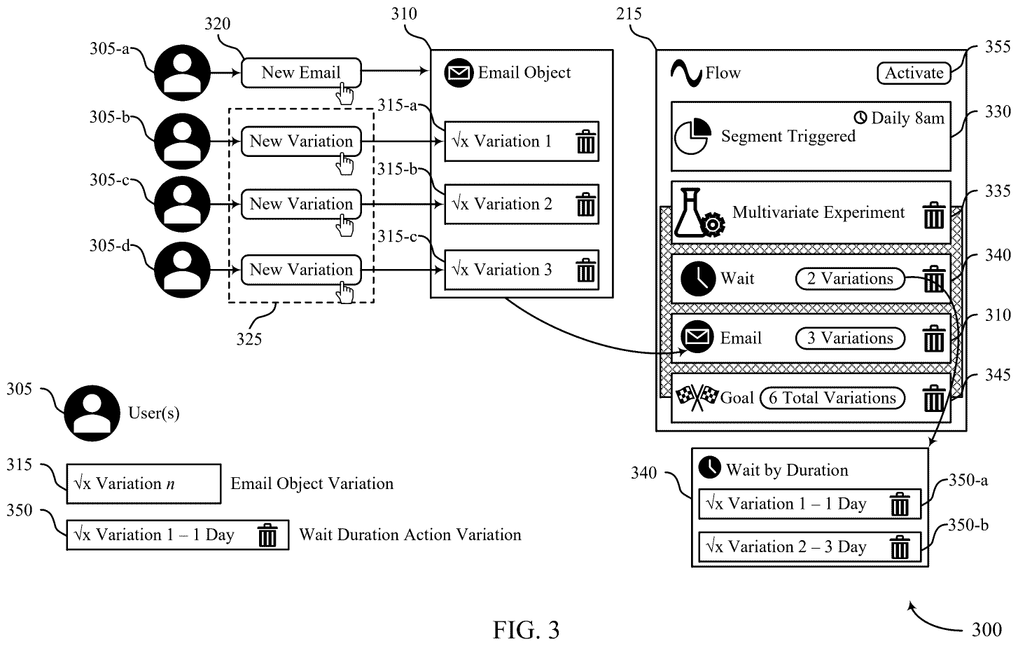

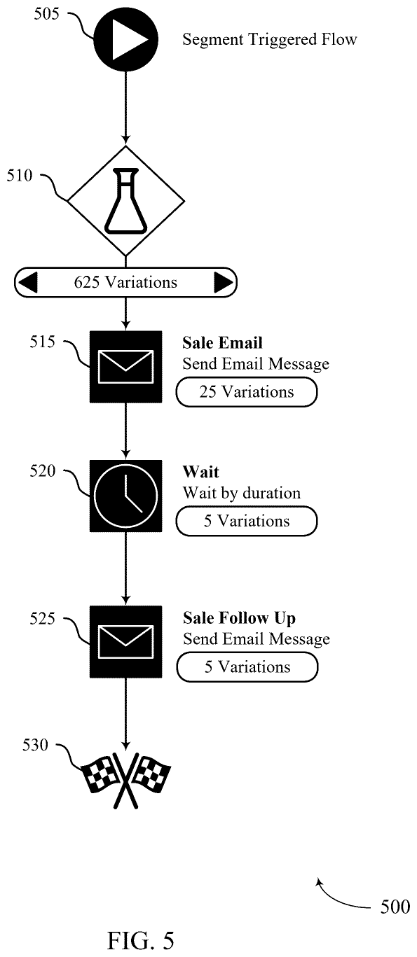

Therefore, the techniques of the present disclosure may enable the server 205 the capability of increasing the reliability and efficiency of the computing system 200 by using the one or more AI/ML models 240 to generate paths to cover each combination of action variations of the communication process flow object 215. Further, the server 205 may use the AI/ML models 240 in accordance with the techniques of the present disclosure to monitor the performance of the respective paths of the communication process flow object 215 for the traffic allocation service 260 of the server 205 to dynamically distribute the traffic based on the performance of the respective paths. Further descriptions of the techniques of the present disclosure enabling the user to generate variations of actions of the communication process flow object 215 may be described elsewhere herein, such as with reference to FIGS. 3 and 5. Moreover, further descriptions of the techniques of the present disclosure enabling the dynamic distribution of the traffic to the one or more user devices 210 may be described elsewhere herein, such as with reference to FIG. 4.

FIG. 3 shows an example of a path variation generation diagram 300 that supports communication process flow path variations in accordance with aspects of the present disclosure. In some examples, the path variation generation diagram 300 may implement or be implemented by the system 100, the computing system 200, or both. For example, the path variation generation diagram 300 may include one or more users 305 (e.g., a user 305-a, a user 305-b, a user 305-c, a user 305-d, or any combination thereof) which may be operating on cloud client 105 or contact 110 described with reference to FIG. 1.

In some examples, the path variation generation diagram 300 may illustrate one or more users 305 generating an email object 310 and variations of the email object (e.g., an email object variation 315-a, an email object variation 315-b, an email object variation 315-c, or any combination thereof). For example, the user 305-a may generate the email object 310 via a first selection component 320 for generating emails. In some cases, the first selection component 320 may be an example of a button that the user 305-a selects to generate the email object 310. Following the generation of the email object 310, one or more users 305 (e.g., the user 305-b, the user 305-c, the user 305-d, or any combination thereof) may generate one or more email object variations 315. In some cases, the one or more users 305 may be examples of email designers or marketing employees of an organization that are responsible for designing an email for a marketing campaign. While designing the email, the one or more users 305 may determine to test different variations of the email, and thus may generate the one or more email object variations 315 as illustrated in the path variation generation diagram 300. For example, the one or more users 305 may generate a set of subject lines for an email and thus may generate the one or more email object variations 315 to test the different subject lines. Further, the one or more users 305 may generate the one or more email object variations 315 via a second selection component 325. In some cases, the second selection component 325 may also be an example of a button that the one or more users 305 may select to generate the one or more email object variations 315. Additionally, or alternatively, the first selection component 320 and the second selection component 325 may be displayed to the one or more users 305 within a first user interface of the server 205, a cloud client 105, a contact 110, or any combination thereof.

Further, within the first user interface, a user of the one or more users 305 may be capable of viewing and editing a communication process flow object 215 as described with reference to FIG. 2. In some examples, the email object 310 may be an example of an action or element of the communication process flow object 215. The communication process flow object 215 may also include one or more additional actions or elements such as a segment trigger action 330, a multivariate experiment action 335, a wait duration action 340, a goal action 345 (e.g., an automation event), or any combination thereof. In some examples, the segment trigger action 330 may indicate a time or condition for the communication process flow object 215 to trigger. For example, if the communication process flow object 215 controls the transmission of emails between an entity and a set of users, the segment trigger action 330 may indicate a time or condition for the transmission of the emails. In some cases, a user (e.g., one of the one or more users 305) may configure the segment trigger action 330 to be such that the emails are transmitted at a given time of day. For example, as illustrated in FIG. 3, a user may configure the segment trigger action 330 to indicate that the emails should be transmitted at 8 am daily. Additionally, or alternatively, a user may further configure the segment trigger action 330 with a time zone relative to the user or relative to a respective user receiving an email. That is, each user receiving an email from a respective path of the communication process flow object 215 may receive the email at the same time regardless of location, or each respective user may receive the email at 8 am local time based on a respective location of a respective user.

In some other cases, a user may configure the segment trigger action 330 to be based on an action or trigger. For example, if the communication process flow object 215 is transmitting emails related to an electronic commerce (e-commerce) website to attempt to get users to purchase goods from the e-commerce website, a user may configure the segment trigger action 330 to be based on a discount being applied to one or more items or goods on the e-commerce website. That is, the communication process flow object 215 may transmit emails to users based on a discount or reduction in price being applied to one or more items being sold on the e-commerce website. In another example, a user may configure the segment trigger action 330 to trigger the transmission of an email based on a user creating an account on the e-commerce website. For example, when a user creates an account on the e-commerce website, the e-commerce merchant may transmit an email to the user with a coupon or voucher for a one time reduction of price in one or more items.

Further, in addition to the segment trigger action 330, a user may generate a multivariate experiment action 335 for the communication process flow object 215. In some examples, the multivariate experiment action 335 may define an experiment to be tested using the different paths of the communication process flow object 215. For example, a user may configure the multivariate experiment action 335 to test the respective paths of the communication process flow object 215 for a duration to determine which path provides relatively better results. Additionally, or alternatively, an AI/ML model may manage the multivariate experiment action 335. That is, a user may use an AI/ML model to monitor the results of the paths of the communication process flow object 215 based on a configuration of the multivariate experiment action 335. Further, in some examples, the user may configure the multivariate experiment action 335 with a threshold for the AI/ML model to use in determining the performance of a respective path of the communication process flow object 215. For example, the user may configure the multivariate experiment action 335 with a performance metric threshold such that the AI/ML model may determine in a respective path of the communication process flow object 215 satisfies (e.g., meets or exceeds) the performance metric threshold. In some cases, the performance metric threshold may be an example of a user engagement metric threshold that is based on a user's engagement with an email. Further, user engagement metrics may include an open rate metric, a click rate metric, a click-to-open rate, an interaction with the content of an email, or any combination thereof. Moreover, in some examples, the performance metric threshold may be a percentage threshold. For example, a user may configure the performance metric threshold as a 70% engagement threshold such that the AI/ML model determines a respective path as successful if at least 70% of the users receiving a respective variation of the one or more email object variations 315 interact or engage with the email object 310. Further descriptions of the multivariate experiment action 335 may be described elsewhere herein, such as with reference to FIG. 4.

Further, a user may also configure the communication process flow object 215 with the wait duration action 340. The wait duration action 340 may indicate a duration (e.g., hours, days, weeks, months, or any combination thereof) that the communication process flow object 215 should wait before sending a follow up email to a user. In some examples, the user may configure the wait duration action 340 with one or more wait duration action variations 350 (e.g., a wait duration action 350-a, a wait duration action 350-b, or both). In some cases, the wait duration action 350-a may indicate that the communication process flow object 215 should wait one day before transmitting a follow-up email and the wait duration action 350-b may indicate that the communication process flow object 215 should wait 3 days before transmitting the follow-up email. Therefore, the respective paths of the communication process flow object 215 may include different variations of the one or more wait duration action variations 350 to test each combination of the one or more wait duration action variations 350 and the one or more other actions of the communication process flow object 215. For example, a first path may include an initial transmission of the email object variation 315-a and then may use the wait duration action 350-a to determine when to transmit a follow-up email. Further, a second path may include the initial transmission of the email object variation 315-a and then may use the wait duration action 350-b to determine the follow-up email transmission time. Therefore, the communication process flow object 215 may include a set of paths that indicate each possible combination of the actions and action variations of the communication process flow object 215.

Additionally, or alternatively, a user may configure the communication process flow object 215 with the goal action 345 (e.g., the automation event). The goal action 345 may be used in conjunction with or separately from the performance metrics defined in the configuration of the multivariate experiment action 335 to assist the AI/ML model in determining the success of a respective path of the communication process flow object 215. For example, the goal action 345 may indicate a condition of a user purchasing a defined item based on interacting with the email transmitted from the communication process flow object 215. In some cases, the AI/ML model may analyze a set of data from a data platform external to the communication process flow object 215 to determine if a condition of the goal action 345 is satisfied. Further, in some examples, the user may configure one or more variations for the goal action 345 or automation event. Additionally, or alternatively, as illustrated by the shaded box behind the multivariate experiment action 335, the wait duration action 340, the email object 310, and the goal action 345 or automation event may indicate that the AI/ML model may manage such actions. For example, as described elsewhere herein, the AI/ML model may use the multiple variations of the email object 310, the wait duration action 340, the goal action 345, or any combination thereof, to generate a set of paths for the communication process flow object 215 to be used for the multivariate experiment action 335. Further, the AI/ML model may manage and determine the traffic allocation for the set of paths based on the configuration of the multivariate experiment action 335. Moreover, it should be understood by one having ordinary skill in the art that an automation event may be associated with the one or more conditions of a goal 245 such that the event (e.g., triggering users to be routed to a flow or triggering an update to the training of the AI/ML models 240) is triggered or executed in response to the goal 245 being satisfied.

Therefore, once a user completes the configuration of the communication process flow object 215 with the one or more actions of the communication process flow object 215, the user may select a third selection component 355 to activate the communication process flow object 215. In some examples, the third selection component 355 may be an example of a button that a user can select to activate the communication process flow object 215. Further descriptions of the activation of the communication process flow object 215 and the testing of the set of paths of the communication process flow object 215 in accordance with the configurations of the one or more actions of the communication process flow object 215 may be described elsewhere herein, such as with reference to FIG. 4.

FIG. 4 shows an example of a path variation testing diagram 400 that supports communication process flow path variations in accordance with aspects of the present disclosure. In some examples, the path variation testing diagram 400 may implement or be implemented by the system 100, the computing system 200, the path variation generation diagram 300, or any combination thereof. For example, the path variation testing diagram 400 may include a communication process flow object 215 as described with reference to FIG. 2 which may be configured and activated via an activation selection component 405 (e.g., a button) by a user operating on a cloud client 105 or a contact 110 described with reference to FIG. 1.

As described with reference to FIG. 3, a user may configure the communication process flow object 215 with one or more actions to control the electronic communications (e.g., email transmissions) between an entity (e.g., an organization) and a set of users. Further, an AI/ML model may be used to generate a set of paths of each possible combination of actions and action variations of the communication process flow object 215 such that a user may conduct an accurate test of the action variations of the communication process flow object 215. For example, as illustrated, if there are two wait duration action variations, three email object variations, and six goal action variations (e.g., automation event variations), the AI/ML model may generate a total of 36 paths for the communication process flow object 215. That is, a quantity of paths that are independent from each other may be equivalent to a product of the quantity of variations for each action that is associated with two or more variations. Therefore, since there are two wait duration action variations, three email object variations, and six goal action variations, the total quantity of paths may be determined as a product of two, three, and six (e.g., 2*3*6). Further, it should be understood that such actions, actions with variations, and variation quantities may be examples and the communication process flow object 215 may include additional actions, different actions may be associated with variations, and different quantities of variations for a respective action.

Therefore, as the quantity of variations for actions increases, the quantity of actions with two or more variations increases, or both, the quantity of paths may drastically increase accordingly. For example, if a user adds an additional wait duration action variation for a total of three wait duration action variations, the total quantity of paths may increase from 36 to 54. In another example, if the user adds two variations for a segment trigger action (e.g., the segment trigger action 330 described with reference to FIG. 3), the total quantity of paths may increase from 36 to 72. Moreover, if the user both adds an additional wait duration action variation and adds two variations for the segment trigger action, the total quantity of paths may increase from 36 to 108. Therefore, having the AI/ML model generate and manage the respective paths for the communication process flow object 215 may be relatively time-efficient and provide for an increase in accuracy as the likelihood of a user generating a relatively large quantity of paths (e.g., more than 2 or 3 paths) may be relatively low. Further, as described elsewhere herein, the techniques of the present disclosure may describe enhancements to a server (e.g., the server 205 described with reference to FIG. 2) to enable the user the capability of generating variations for two or more actions of the communication process flow object 215. That is, the techniques of the present disclosure may enable a server to store two or more variations for two or more actions of the communication process flow object 215 for an AI/ML model to use to generate a set of paths for the communication process flow object 215. Further, these techniques may reduce communication resource overhead, as users are dynamically routed to paths based on path performance, communication resources may not be used on lower performing paths.

Thus, once the user has completed the configuration of the communication process flow object 215 and the AI/ML model has generated the set of paths of the communication process flow object 215, the user may select the activation selection component 405 to activate the communication process flow object 215. In some examples, the activation of the communication process flow object 215 via the activation selection component 405 may include an initiation of a multivariate experiment 410 of the communication process flow object 215 (e.g., the multivariate experiment action 335 described with reference to FIG. 3). In some cases, the multivariate experiment action may indicate the set of parameters for an AI/ML model to use when performing the multivariate experiment. For example, the multivariate experiment action may indicate a duration parameter that indicates a duration for the multivariate experiment. As illustrated herein, the multivariate experiment may have a duration of 30 days.

In some examples, the configuration of the multivariate experiment 410 may also indicate an initial variation traffic distribution 415. The initial variation traffic distribution 415 may indicate how the communication process flow object 215 may distribute the traffic across the two or more paths or variations 420 of the communication process flow object 215. For example, as illustrated herein, the initial variation traffic distribution 415 may distribute the traffic evenly across the variations 420 of the communication process flow object 215. Further, it should be understood that the paths of the communication process flow object 215 may also be referred to as variations 420 elsewhere herein.

Therefore, the communication process flow object 215 may transmit one or more emails to a set of users in accordance with an even distribution of the set of users across the variations 420 of the communication process flow object 215. During the execution of the communication process flow object 215, the AI/ML model may monitor the performance of each respective variation 420 and dynamically adjust the distribution of traffic. For example, the AI/ML model may determine that a first variation is performing relatively better than a second variation which may result in an increase in users being routed to a path associated with the first variation rather than a path associated with the second variation. Further, during the execution, a user may observe the current distribution metrics via a metrics panel of a user interface (e.g., the first user interface used to generate the communication process flow object 215 or a separate second user interface).

Once the duration for the multivariate experiment 410 expires (e.g., after the has been executed for 30 days), a user may receive a notification to review and analyze the results. In some cases, a final variation traffic distribution 425 may display the results to illustrate the traffic distribution across the variations 420 after the execution of the multivariate experiment. In some examples, the final variation traffic distribution 425 may indicate that one or more paths associated with one or more variations 420 may be relatively more successful than the others. For example, the final variation traffic distribution 425 may indicate that a variation 420-a is relatively successful as the AI/ML model determined to route 75% of the set of users to the path associated with the variation 420-a. Further, a variation 420-b may also be relatively successful as the AI/ML model determined to route the remaining 25% of the set of users to the path associated with the variation 420-b rather than any of the remaining paths associated with the remaining variations 420.

In some examples, while analyzing the data, a user may select the variation 420-a for all subsequent communications. In some other examples, the user may determine to continue the multivariate experiment 410 for a second duration. In some cases, the second duration may be the same, longer, or shorter than the initial duration for the multivariate experiment 410. Additionally, or alternatively, the user may determine to edit the action variations of the communication process flow object 215 to enable the AI/ML model in generating variations 420 and associated paths similar to the variation 420-a and the variation 420-b. Therefore, the user may reactivate the communication process flow object 215 via the activation selection component 405 to rerun the multivariate experiment 410. In another example, the user may enable the AI/ML model to generate one or more similar variations and corresponding paths based on the variation 420-a and the variation 420-b. For example, the AI/ML model may use generative AI techniques to generate additional action variations, replace action variations, or both, to generate variations 420 of the communication process flow object 215 that are similar to the variation 420-a, the variation 420-b, or both.

Therefore, in accordance with the techniques of the present disclosure, users may configure and use AI/ML models to autonomously route users to different paths of the communication process flow object 215 based on performance. Further, the AI/ML models may be capable of learning both which paths (e.g., which combinations of action variations) result in an increase in performance and which action variations result in an increase in performance. For example, if a communication process flow object 215 is associated with a relatively large quantity of actions and each action is associated with a relatively large quantity of variations, the quantity of data from the execution of the communication process flow object 215 may be relatively large. Therefore, in accordance with the techniques of the present disclosure, an AI/ML model may analyze the data to determine which paths result in an increase in performance. Based on the path performance, the AI/ML model may be capable of determining one or more performance metrics of individual action variations. For example, if each path associated with a first variation of an email results in an increase in performance compared to a second variation of the email, the AI/ML model may begin to route users to paths associated with the first variation of the email over paths associated with the second variation of the email.

Further, the techniques of the present disclosure may enable the AI/ML model to use data from the one or more actions of the communication process flow object 215 to determine a successful path. In some cases, the data from the one or more actions may also be received in different formats. For example, a server (e.g., the server 205) may receive a first set of data related to the performance of a first email object variation in a first data format and a second set of data related to the performance of a first wait duration action variation in a second data format. Therefore, the AI/ML model may be used to analyze the first set of data and the second set of data that are in different data to determine both action specific performance metrics and path specific performance metrics. For example, the AI/ML model may generate a third set of data from the first set of data and the second set of data to be within a third data format that is associated with both the first email object variation and the first wait duration action variation. Thus, the techniques of the present disclosure may enable an AI/ML model to analyze different sets of data for a respective path to determine the performance metric of a respective path of the communication process flow object 215. Further descriptions of the AI/ML model being used in accordance with the techniques of the present disclosure may described elsewhere herein, such as with reference to FIG. 5.

FIG. 5 shows an example of a variation process flow 500 that supports communication process flow path variations in accordance with aspects of the present disclosure. In some examples, the variation process flow 500 may implement or be implemented by the system 100, the computing system 200, the path variation generation diagram 300, the path variation testing diagram 400, or any combination thereof. For example, the variation process flow 500 may be based on the path variations that included combinations of action variations of a communication process flow object 215 as described with reference to FIG. 2 which may be configured and activated by a user operating on a cloud client 105 or a contact 110 described with reference to FIG. 1.

In the following description of the variation process flow 500, the operations may be performed by a cloud client 105, a contact 110, one or more AI models (e.g., the AI/ML models 240 described with reference to FIG. 2) in different orders or at different times. Some operations may also be left out of the variation process flow 500, or other operations may be added. Although the variation process flow 500 may be described as being performed by a cloud client 105, a contact 110, one or more AI models, or any combination thereof, some aspects of some operations may also be performed by other devices, services, or models described elsewhere herein including with reference to FIGS. 1 and 2.

In some examples, the variation process flow 500 may be an example of a user interface for a user to visualize the actions of a communication process flow object. For example, the communication process flow may include one or more email objects and a wait duration action. Further, the variation process flow 500 may be an example of a multivariate experiment of a communication process flow object with a single path and two or more elements of the path are configured with two or more variations.

At 505, a communication process flow object that includes one or more actions may be triggered by a segment trigger action (e.g., the segment trigger action 330 described with reference to FIG. 3). The segment trigger action may be an example of an action or rule that is used to determine when the communication process flow object may transmit one or more messages to a set of users. Further, at 510, a multivariate experiment to test a set of path variations may be executed. In some examples, the communication process flow object may include one or more paths that each include three elements, an email element, a wait element, and a follow-up email element. In some cases, the email element may be associated with 25 variations, the wait element may be associated with 5 variations, and the follow-up email element may be associated with 5 variations. Therefore, the multivariate experiment initiated at 510 of a communication process flow object may evaluate each one of the 625 possible element variation combinations for the communication process flow object (e.g., 25 email variations*5 wait variations*5 follow-up email variations=625 path variations).

Thus, at 515, for each respective path, a server associated with the communication process flow object may transmit an initial email to a respective user of a set of users. In some examples, at 515, a subset of users of the set of users may be associated with a respective path variation and therefore may receive a first variation of the email element. In some examples, the 25 different variations of the email element may include combinations of 5 different subject line variations and 5 different hero or banner image (e.g., relatively large images that may span the length of a page) variations (e.g., 5 subject line variations*5 hero image variations=25 different email element variations). After transmitting the different email variations to the set of users, at 520, the server associated with the communication process flow object may wait for a duration determined by the wait element of the communication process flow object. In some examples, the wait element of the communication process flow object may be associated with five variations varying from waiting one day to waiting five days. For example, from the subset of users of the set of users that receive the first variation of the email element, a first subset of users of the subset of users may wait for a quantity of time indicated in a first wait element variation (e.g., one day) and a second subset of users of the subset of users may wait for a quantity of time indicated in a second wait duration element variation (e.g., three days).

Further, at 525, the server associated with the communication process flow object may transmit a follow-up email from one of the follow-up email element variations after waiting the duration indicated in a wait duration element variation of a respective path variation. In some cases, the follow-up email element may be associated with five variations that are separated based on five different subject lines. For example, the server may transmit, after waiting one day as indicated in the first wait element variation, a first set of users a first follow-up email variation that is associated with a first subject line and a second set of users a second follow-up email variation that is associated with a second subject line.

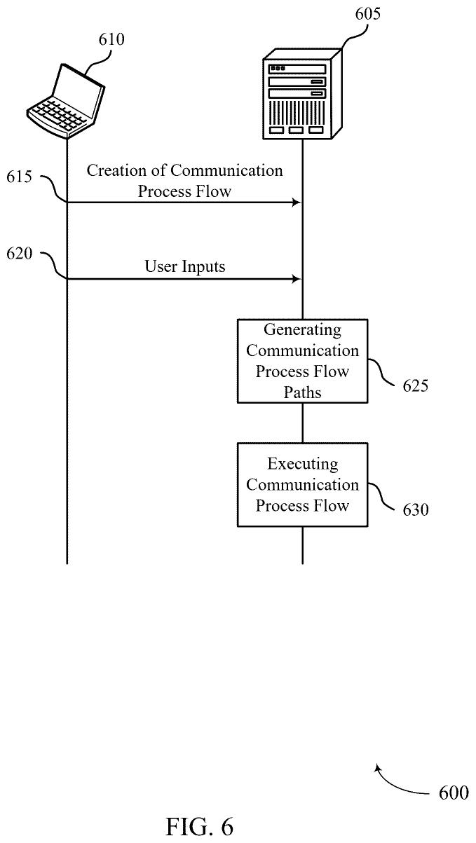

At 530, the AI/ML model managing the communication process flow object may determine if a respective path variation has satisfied a performance metric threshold or goal. In some examples, the AI/ML model may monitor the user engagement with the respective emails and follow-up emails to determine if a respective path variation satisfies a performance metric threshold. For example, the AI/ML model may determine whether a click-to-open rate associated with the email variation and the follow-up email variation of a respective path satisfies a click-to-open rate threshold. In some other examples, the AI/ML model may monitor and analyze data associated with a result of a path to determine if a respective path variation satisfies a goal. For example, the AI/ML model may analyze data, that is stored separately from the communication process flow object, to determine if a condition has been met (e.g., if a specific page has been visited, if a product has been purchases, if a quantity of items have been purchased, if an amount of money has been spent, or any combination thereof). Therefore, as described elsewhere herein, the AI/ML model may be capable of comparing the performance of the respective path variations to dynamically allocate traffic to path variations resulting in higher levels of success. For example, initially, the AI/ML model may distribute users via the different path variations evenly as the AI/ML may be unable to determine which combination of element variations may be relatively more successful. However, over time, the AI/ML model may monitor the performance of the path variations and thus the different combinations of element variations, and therefore may be capable of allocating traffic in a more accurate and efficient manner. Further, the use of an AI/ML model may result in a decrease in time-consumption as such path variation generation and data analysis may be relatively time-consuming. Further descriptions of the techniques of the present disclosure enabling the generation of relatively large quantities of path variations of a communication process flow object and dynamic traffic allocation between the path variations of the communication process flow object may be described elsewhere herein, such as with reference to FIG. 6.

FIG. 6 shows an example of a process flow 600 that supports communication process flow path variations in accordance with aspects of the present disclosure. In some examples, the process flow 600 may implement or may be implemented by the system 100, the computing system 200, the path variation generation diagram 300, the path variation testing diagram 400, the variation process flow 500, or any combination thereof. The process flow 600 may include a server 605 and a computing device 610 which may be examples of devices or services described elsewhere herein including with reference to FIGS. 1 and 2. For example, the server 605 and the computing device 610 may be examples of a cloud client 105, a contact 110, or both, as described with reference to FIG. 1.

In the following description of the process flow 600, the operations may be performed by the server 605 and the computing device 610 in different orders or at different times. Some operations may also be left out of the process flow 600, or other operations may be added. Although the process flow 600 may be described as being performed by the server 605 and the computing device 610, some aspects of some operations may also be performed by other devices, services, or models described elsewhere herein including with reference to FIGS. 1 and 2.

At 615, the computing device 610 may transmit, to the server 605, an indication of a creation of a communication process flow. The communication process flow may include a set of actions that control electronic communications between an entity and a set of users. At 620, the computing device 610 may transmit, to the server 605, one or more user inputs that indicate at least two first action variations of a first action of the set of actions and at least two second action variations of a second action of the set of actions. In some examples, the computing device 610 may transmit, to the server 605, a second user input that indicates a duration of time for monitoring the communication process flow, where the communication process flow is monitored for the duration of time based on the server 205 receiving the second user input. In some other examples, the computing device 610 may transmit, to the server 605, one or more second user inputs that indicate at least two third action variations of a third action of the set of actions, the at least two third action variations corresponding to two or more goals for the set of paths of the communication process flow, the two or more goals being based on data stored within a data platform that is separate from the communication process flow. Further, in some cases, the first action of the set of actions may be an example of an email action and the second action of the set of actions may be an example of a wait duration action. Additionally, or alternatively, a variation creation selection component may be displayed via a first user interface of the computing device 610 that accesses the server 605 such that the server 605 receives the one or more user inputs via the variation creation selection component or based on a selection of the variation creation selection component.

At 625, the server 605 may generate the communication process flow based on receiving the indication of the at least two first action variations and the at least two second action variations. Further, the communication process flow may include a set of paths for a set of combinations of the at least two first action variations and the at least two second action variations. In some cases, a respective path for each action variation combination may include a respective combination of the set of combinations of the at least two first action variations and the at least two second action variations. Moreover, the server 605 may generate the set of paths using each possible combination of the at least two first action variations and the at least two second action variations based on receiving the one or more user inputs. In some examples, the server 605 may generate, via an ML model (e.g., an AI/ML model), at least one first action variation of the first action of the set of actions in addition to the at least two first action variations and at least one second action variation of the second action of the set of actions in addition to the at least two second action variations. In some cases, the server 605 may generate the at least one first action variation and the at least one second action variation based on receiving the one or more user inputs.

At 630, the server 605 may execute, for the set of users, the communication process flow which includes the set of paths. In some examples, after execution, the server 605 may monitor the communication process flow to obtain a set of performance metrics for the set of paths of the communication process flow. In some cases, a respective performance metric for a respective path of the set of paths may be associated with a respective combination of the at least two first action variations and the at least two second action variations of the set of combinations. Therefore, the server 605 may route the set of users via one or more paths of the set of paths of the communication process flow based on a respective performance metric of the one or more paths, the one or more paths being associated with one or more respective combinations of the set of combinations of the at least two first action variations and the at least two second action variations. Additionally, or alternatively, the server 605 may route the set of users via the one or more paths based on the respective performance metric of the one or more paths satisfying a performance metric threshold. In some other cases, the server 605 may route the set of users via one or more paths of the set of paths of the communication process flow based on a result of the one or more paths satisfying at least one goal of the two or more goals. Further, the one or more paths may be associated with one or more respective combinations of the set of combinations of the at least two first action variations and the at least two second action variations. Therefore, the server 605 may route the set of users via the one or more paths of the set of paths based on the at least one goal of the two or more goals being satisfied a threshold quantity of times.

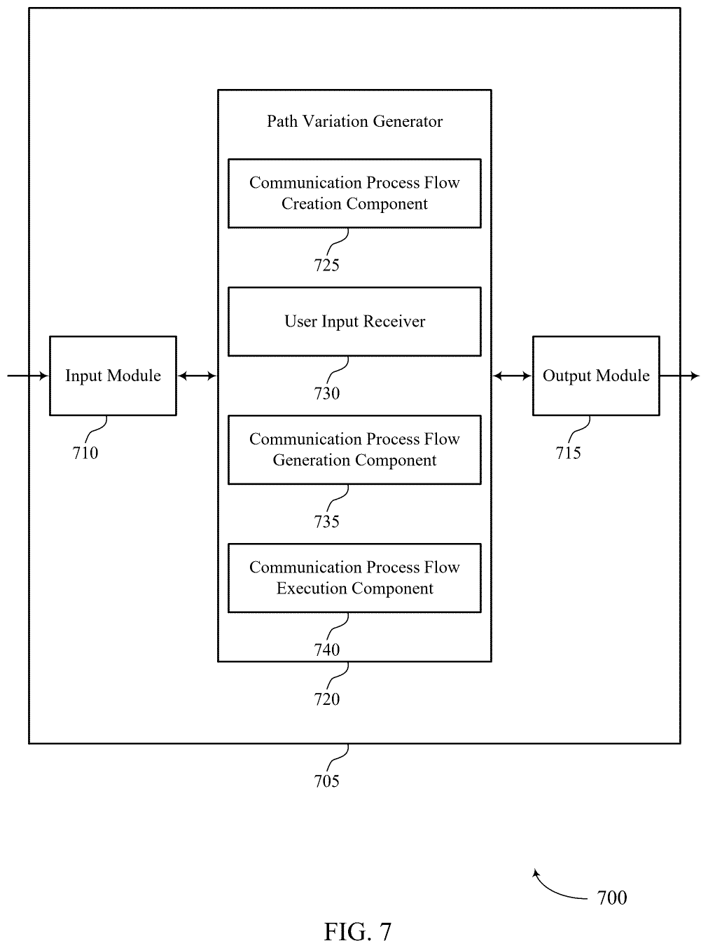

FIG. 7 shows a block diagram 700 of a device 705 that supports communication process flow path variations in accordance with aspects of the present disclosure. The device 705 may include an input module 710, an output module 715, and a path variation generator 720. The device 705, or one or more components of the device 705 (e.g., the input module 710, the output module 715, the path variation generator 720), may include at least one processor, which may be coupled with at least one memory, to support the described techniques. Each of these components may be in communication with one another (e.g., via one or more buses).

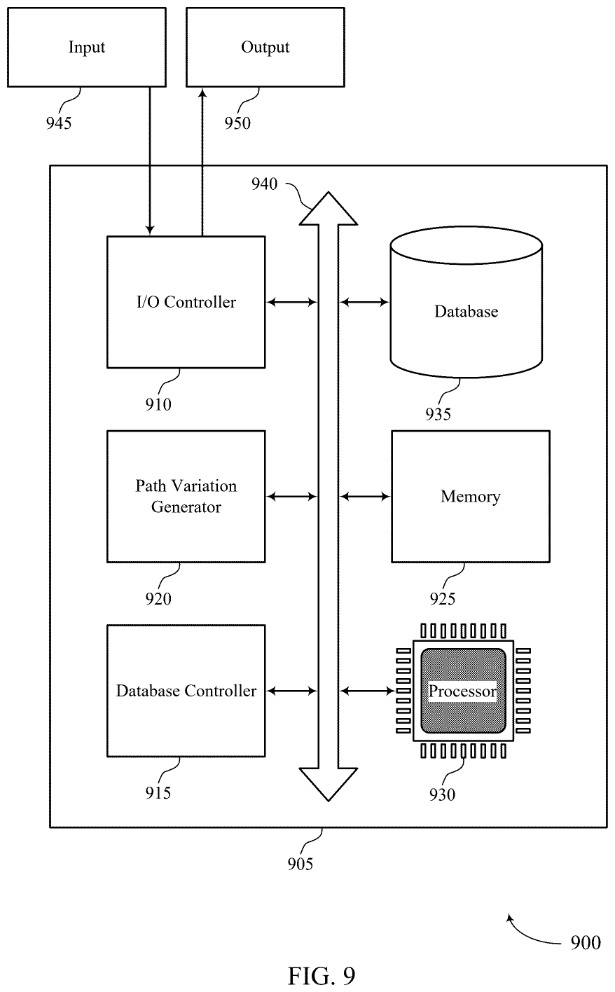

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the path variation generator 720 to support communication process flow path variations. In some cases, the input module 710 may be a component of an input/output (I/O) controller 910 as described with reference to FIG. 9.

The output module 715 may manage output signals for the device 705. For example, the output module 715 may receive signals from other components of the device 705, such as the path variation generator 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the path variation generator 720 may include a communication process flow creation component 725, a user input receiver 730, a communication process flow generation component 735, a communication process flow execution component 740, or any combination thereof. In some examples, the path variation generator 720, or various components thereof, may be configured to perform various operations (e.g., receiving, monitoring, transmitting) using or otherwise in cooperation with the input module 710, the output module 715, or both. For example, the path variation generator 720 may receive information from the input module 710, send information to the output module 715, or be integrated in combination with the input module 710, the output module 715, or both to receive information, transmit information, or perform various other operations as described herein.

The path variation generator 720 may support data processing in accordance with examples as disclosed herein. The communication process flow creation component 725 may be configured to support receiving an indication of a creation of a communication process flow, the communication process flow including a set of multiple actions that control electronic communications between an entity and a set of multiple users. The user input receiver 730 may be configured to support receiving one or more user inputs that indicates at least two first action variations of a first action of the set of multiple actions and at least two second action variations of a second action of the set of multiple actions. The communication process flow generation component 735 may be configured to support generating, based on receiving the indication of the at least two first action variations and the at least two second action variations, the communication process flow including a set of multiple paths for a set of multiple combinations of the at least two first action variations and the at least two second action variations. The communication process flow execution component 740 may be configured to support executing, for the set of multiple users, the communication process flow including the set of multiple paths.

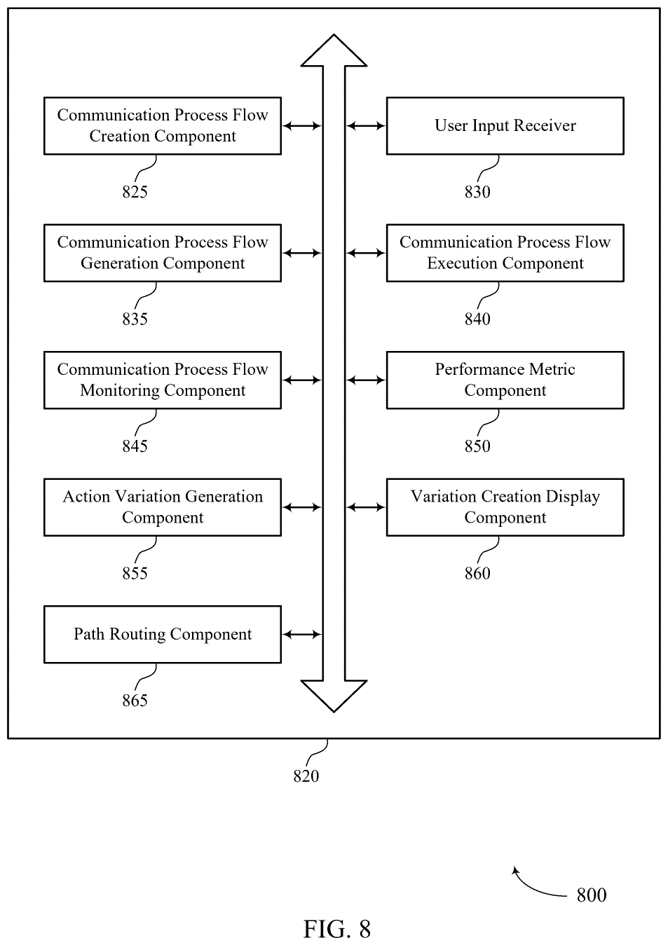

FIG. 8 shows a block diagram 800 of a path variation generator 820 that supports communication process flow path variations in accordance with aspects of the present disclosure. The path variation generator 820 may be an example of aspects of a path variation generator or a path variation generator 720, or both, as described herein. The path variation generator 820, or various components thereof, may be an example of means for performing various aspects of communication process flow path variations as described herein. For example, the path variation generator 820 may include a communication process flow creation component 825, a user input receiver 830, a communication process flow generation component 835, a communication process flow execution component 840, a communication process flow monitoring component 845, a performance metric component 850, an action variation generation component 855, a variation creation display component 860, a path routing component 865, or any combination thereof. Each of these components, or components of subcomponents thereof (e.g., one or more processors, one or more memories), may communicate, directly or indirectly, with one another (e.g., via one or more buses).

The path variation generator 820 may support data processing in accordance with examples as disclosed herein. The communication process flow creation component 825 may be configured to support receiving an indication of a creation of a communication process flow, the communication process flow including a set of multiple actions that control electronic communications between an entity and a set of multiple users. The user input receiver 830 may be configured to support receiving one or more user inputs that indicates at least two first action variations of a first action of the set of multiple actions and at least two second action variations of a second action of the set of multiple actions. The communication process flow generation component 835 may be configured to support generating, based on receiving the indication of the at least two first action variations and the at least two second action variations, the communication process flow including a set of multiple paths for a set of multiple combinations of the at least two first action variations and the at least two second action variations. The communication process flow execution component 840 may be configured to support executing, for the set of multiple users, the communication process flow including the set of multiple paths.

In some examples, a respective path for each action variation combination includes a respective combination of the set of multiple combinations of the at least two first action variations and the at least two second action variations.

In some examples, to support generating the communication process flow, the communication process flow generation component 835 may be configured to support generating the set of multiple paths of using each possible combination of the at least two first action variations and the at least two second action variations based on receiving the one or more user inputs.

In some examples, the communication process flow monitoring component 845 may be configured to support monitoring the communication process flow based on executing the communication process flow for the set of multiple users. In some examples, the performance metric component 850 may be configured to support obtaining a set of multiple performance metrics for the set of multiple paths of the communication process flow, a respective performance metric for a respective path of the set of multiple paths being associated with a respective combination of the at least two first action variations and the at least two second action variations of the set of multiple combinations, where the set of multiple performance metrics are obtained based on monitoring the communication process flow.

In some examples, the user input receiver 830 may be configured to support receiving a second user input that indicates a duration of time for monitoring the communication process flow, where the communication process flow is monitored for the duration of time based on receiving the second user input.

In some examples, the path routing component 865 may be configured to support routing the set of multiple users via one or more paths of the set of multiple paths of the communication process flow based on a respective performance metric of the one or more paths, the one or more paths being associated with one or more respective combinations of the set of multiple combinations of the at least two first action variations and the at least two second action variations.

In some examples, to support routing the set of multiple users via the one or more paths, the path routing component 865 may be configured to support routing the set of multiple users via the one or more paths based on the respective performance metric of the one or more paths satisfying a performance metric threshold.

In some examples, the set of multiple performance metrics indicate user engagement metrics.

In some examples, the user input receiver 830 may be configured to support receiving one or more second user inputs that indicate at least two third action variations of a third action of the set of multiple actions, the at least two third action variations corresponding to two or more goals for the set of multiple paths of the communication process flow, the two or more goals being based on data stored within a data platform that is separate from the communication process flow.

In some examples, the path routing component 865 may be configured to support routing the set of multiple users via one or more paths of the set of multiple paths of the communication process flow based on a result of the one or more paths satisfying at least one goal of the two or more goals, the one or more paths being associated with one or more respective combinations of the set of multiple combinations of the at least two first action variations and the at least two second action variations.

In some examples, the set of multiple users are routed via the one or more paths of the set of multiple paths based on the at least one goal of the two or more goals being satisfied a threshold quantity of times.

In some examples, the action variation generation component 855 may be configured to support generating, via a machine learning model, at least one first action variation of the first action of the set of multiple actions in addition to the at least two first action variations and at least one second action variation of the second action of the set of multiple actions in addition to the at least two second action variations.

In some examples, the at least one first action variation and the at least one second action variation are generated based on receiving the one or more user inputs.

In some examples, the first action of the set of multiple actions is an email action and the second action of the set of multiple actions is a wait duration action.

In some examples, the variation creation display component 860 may be configured to support displaying, via a first user interface, a variation creation selection component, where the one or more user inputs are received via the variation creation selection component.

FIG. 9 shows a diagram of a system 900 including a device 905 that supports communication process flow path variations in accordance with aspects of the present disclosure. The device 905 may be an example of or include components of a device 705 as described herein. The device 905 may include components for bi-directional data communications including components for transmitting and receiving communications, such as a path variation generator 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting communication process flow path variations). The processor 930 may be an example of a single processor or multiple processors. For example, the device 905 may include one or more processors 930.

The path variation generator 920 may support data processing in accordance with examples as disclosed herein. For example, the path variation generator 920 may be configured to support receiving an indication of a creation of a communication process flow, the communication process flow including a set of multiple actions that control electronic communications between an entity and a set of multiple users. The path variation generator 920 may be configured to support receiving one or more user inputs that indicates at least two first action variations of a first action of the set of multiple actions and at least two second action variations of a second action of the set of multiple actions. The path variation generator 920 may be configured to support generating, based on receiving the indication of the at least two first action variations and the at least two second action variations, the communication process flow including a set of multiple paths for a set of multiple combinations of the at least two first action variations and the at least two second action variations. The path variation generator 920 may be configured to support executing, for the set of multiple users, the communication process flow including the set of multiple paths.

By including or configuring the path variation generator 920 in accordance with examples as described herein, the device 905 may support generating a relatively large quantity of communication process flow path variations via AI and ML models to support improved communication reliability, improved user experience related to the improved communication reliability, more efficient utilization of communication resources, and an increase in efficiency of a communication process flow.

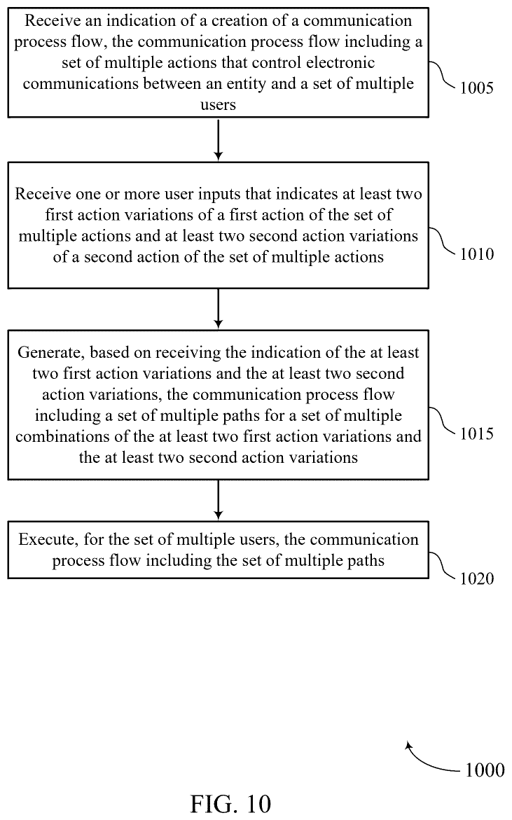

FIG. 10 shows a flowchart illustrating a method 1000 that supports communication process flow path variations in accordance with aspects of the present disclosure. The operations of the method 1000 may be implemented by a computing device or its components as described herein. For example, the operations of the method 1000 may be performed by a computing device as described with reference to FIGS. 1 through 9. In some examples, a computing device may execute a set of instructions to control the functional elements of the computing device to perform the described functions.

Additionally, or alternatively, the computing device may perform aspects of the described functions using special-purpose hardware.

At 1005, the method may include receiving an indication of a creation of a communication process flow, the communication process flow including a set of multiple actions that control electronic communications between an entity and a set of multiple users. The operations of 1005 may be performed in accordance with examples as disclosed herein. In some examples, aspects of the operations of 1005 may be performed by a communication process flow creation component 825 as described with reference to FIG. 8.

At 1010, the method may include receiving one or more user inputs that indicates at least two first action variations of a first action of the set of multiple actions and at least two second action variations of a second action of the set of multiple actions. The operations of 1010 may be performed in accordance with examples as disclosed herein. In some examples, aspects of the operations of 1010 may be performed by a user input receiver 830 as described with reference to FIG. 8.

At 1015, the method may include generating, based on receiving the indication of the at least two first action variations and the at least two second action variations, the communication process flow including a set of multiple paths for a set of multiple combinations of the at least two first action variations and the at least two second action variations. The operations of 1015 may be performed in accordance with examples as disclosed herein. In some examples, aspects of the operations of 1015 may be performed by a communication process flow generation component 835 as described with reference to FIG. 8.

At 1020, the method may include executing, for the set of multiple users, the communication process flow including the set of multiple paths. The operations of 1020 may be performed in accordance with examples as disclosed herein. In some examples, aspects of the operations of 1020 may be performed by a communication process flow execution component 840 as described with reference to FIG. 8.

A method for data processing by an apparatus is described. The method may include receiving an indication of a creation of a communication process flow, the communication process flow including a set of multiple actions that control electronic communications between an entity and a set of multiple users, receiving one or more user inputs that indicates at least two first action variations of a first action of the set of multiple actions and at least two second action variations of a second action of the set of multiple actions, generating, based on receiving the indication of the at least two first action variations and the at least two second action variations, the communication process flow including a set of multiple paths for a set of multiple combinations of the at least two first action variations and the at least two second action variations, and executing, for the set of multiple users, the communication process flow including the set of multiple paths.

An apparatus for data processing is described. The apparatus may include one or more memories storing processor executable code, and one or more processors coupled with the one or more memories. The one or more processors may individually or collectively be operable to execute the code to cause the apparatus to receive an indication of a creation of a communication process flow, the communication process flow including a set of multiple actions that control electronic communications between an entity and a set of multiple users, receive one or more user inputs that indicates at least two first action variations of a first action of the set of multiple actions and at least two second action variations of a second action of the set of multiple actions, generate, based on receiving the indication of the at least two first action variations and the at least two second action variations, the communication process flow including a set of multiple paths for a set of multiple combinations of the at least two first action variations and the at least two second action variations, and execute, for the set of multiple users, the communication process flow including the set of multiple paths.

Another apparatus for data processing is described. The apparatus may include means for receiving an indication of a creation of a communication process flow, the communication process flow including a set of multiple actions that control electronic communications between an entity and a set of multiple users, means for receiving one or more user inputs that indicates at least two first action variations of a first action of the set of multiple actions and at least two second action variations of a second action of the set of multiple actions, means for generating, based on receiving the indication of the at least two first action variations and the at least two second action variations, the communication process flow including a set of multiple paths for a set of multiple combinations of the at least two first action variations and the at least two second action variations, and means for executing, for the set of multiple users, the communication process flow including the set of multiple paths.

A non-transitory computer-readable medium storing code for data processing is described. The code may include instructions executable by one or more processors to receive an indication of a creation of a communication process flow, the communication process flow including a set of multiple actions that control electronic communications between an entity and a set of multiple users, receive one or more user inputs that indicates at least two first action variations of a first action of the set of multiple actions and at least two second action variations of a second action of the set of multiple actions, generate, based on receiving the indication of the at least two first action variations and the at least two second action variations, the communication process flow including a set of multiple paths for a set of multiple combinations of the at least two first action variations and the at least two second action variations, and execute, for the set of multiple users, the communication process flow including the set of multiple paths.

In some examples of the method, apparatus, and non-transitory computer-readable medium described herein, a respective path for each action variation combination includes a respective combination of the set of multiple combinations of the at least two first action variations and the at least two second action variations.

In some examples of the method, apparatus, and non-transitory computer-readable medium described herein, generating the communication process flow may include operations, features, means, or instructions for generating the set of multiple paths of using each possible combination of the at least two first action variations and the at least two second action variations based on receiving the one or more user inputs.

Some examples of the method, apparatus, and non-transitory computer-readable medium described herein may further include operations, features, means, or instructions for monitoring the communication process flow based on executing the communication process flow for the set of multiple users and obtaining a set of multiple performance metrics for the set of multiple paths of the communication process flow, a respective performance metric for a respective path of the set of multiple paths being associated with a respective combination of the at least two first action variations and the at least two second action variations of the set of multiple combinations, where the set of multiple performance metrics may be obtained based on monitoring the communication process flow.

Some examples of the method, apparatus, and non-transitory computer-readable medium described herein may further include operations, features, means, or instructions for receiving a second user input that indicates a duration of time for monitoring the communication process flow, where the communication process flow may be monitored for the duration of time based on receiving the second user input.

Some examples of the method, apparatus, and non-transitory computer-readable medium described herein may further include operations, features, means, or instructions for routing the set of multiple users via one or more paths of the set of multiple paths of the communication process flow based on a respective performance metric of the one or more paths, the one or more paths being associated with one or more respective combinations of the set of multiple combinations of the at least two first action variations and the at least two second action variations.

In some examples of the method, apparatus, and non-transitory computer-readable medium described herein, routing the set of multiple users via the one or more paths may include operations, features, means, or instructions for routing the set of multiple users via the one or more paths based on the respective performance metric of the one or more paths satisfying a performance metric threshold.

In some examples of the method, apparatus, and non-transitory computer-readable medium described herein, the set of multiple performance metrics indicate user engagement metrics.

Some examples of the method, apparatus, and non-transitory computer-readable medium described herein may further include operations, features, means, or instructions for receiving one or more second user inputs that indicate at least two third action variations of a third action of the set of multiple actions, the at least two third action variations corresponding to two or more goals for the set of multiple paths of the communication process flow, the two or more goals being based on data stored within a data platform that may be separate from the communication process flow.

Some examples of the method, apparatus, and non-transitory computer-readable medium described herein may further include operations, features, means, or instructions for routing the set of multiple users via one or more paths of the set of multiple paths of the communication process flow based on a result of the one or more paths satisfying at least one goal of the two or more goals, the one or more paths being associated with one or more respective combinations of the set of multiple combinations of the at least two first action variations and the at least two second action variations.

In some examples of the method, apparatus, and non-transitory computer-readable medium described herein, the set of multiple users may be routed via the one or more paths of the set of multiple paths based on the at least one goal of the two or more goals being satisfied a threshold quantity of times.

Some examples of the method, apparatus, and non-transitory computer-readable medium described herein may further include operations, features, means, or instructions for generating, via a machine learning model, at least one first action variation of the first action of the set of multiple actions in addition to the at least two first action variations and at least one second action variation of the second action of the set of multiple actions in addition to the at least two second action variations.

In some examples of the method, apparatus, and non-transitory computer-readable medium described herein, the at least one first action variation and the at least one second action variation may be generated based on receiving the one or more user inputs.

In some examples of the method, apparatus, and non-transitory computer-readable medium described herein, the first action of the set of multiple actions may be an email action and the second action of the set of multiple actions may be a wait duration action.

Some examples of the method, apparatus, and non-transitory computer-readable medium described herein may further include operations, features, means, or instructions for displaying, via a first user interface, a variation creation selection component, where the one or more user inputs may be received via the variation creation selection component.

The following provides an overview of aspects of the present disclosure:

Aspect 1: A method for data processing, comprising: receiving an indication of a creation of a communication process flow, the communication process flow comprising a plurality of actions that control electronic communications between an entity and a plurality of users; receiving one or more user inputs that indicates at least two first action variations of a first action of the plurality of actions and at least two second action variations of a second action of the plurality of actions; generating, based at least in part on receiving the indication of the at least two first action variations and the at least two second action variations, the communication process flow comprising a plurality of paths for a plurality of combinations of the at least two first action variations and the at least two second action variations; and executing, for the plurality of users, the communication process flow comprising the plurality of paths.

Aspect 2: The method of aspect 1, wherein a respective path for each action variation combination comprises a respective combination of the plurality of combinations of the at least two first action variations and the at least two second action variations.

Aspect 3: The method of any of aspects 1 through 2, wherein generating the communication process flow comprises: generating the plurality of paths of using each possible combination of the at least two first action variations and the at least two second action variations based at least in part on receiving the one or more user inputs.

Aspect 4: The method of any of aspects 1 through 3, further comprising: monitoring the communication process flow based at least in part on executing the communication process flow for the plurality of users; and obtaining a plurality of performance metrics for the plurality of paths of the communication process flow, a respective performance metric for a respective path of the plurality of paths being associated with a respective combination of the at least two first action variations and the at least two second action variations of the plurality of combinations, wherein the plurality of performance metrics are obtained based at least in part on monitoring the communication process flow.

Aspect 5: The method of aspect 4, further comprising: receiving a second user input that indicates a duration of time for monitoring the communication process flow, wherein the communication process flow is monitored for the duration of time based at least in part on receiving the second user input.

Aspect 6: The method of any of aspects 4 through 5, further comprising: routing the plurality of users via one or more paths of the plurality of paths of the communication process flow based at least in part on a respective performance metric of the one or more paths, the one or more paths being associated with one or more respective combinations of the plurality of combinations of the at least two first action variations and the at least two second action variations.

Aspect 7: The method of aspect 6, wherein routing the plurality of users via the one or more paths comprises: routing the plurality of users via the one or more paths based at least in part on the respective performance metric of the one or more paths satisfying a performance metric threshold.

Aspect 8: The method of any of aspects 4 through 7, wherein the plurality of performance metrics indicate user engagement metrics.

Aspect 9: The method of any of aspects 1 through 8, further comprising: receiving one or more second user inputs that indicate at least two third action variations of a third action of the plurality of actions, the at least two third action variations corresponding to two or more goals for the plurality of paths of the communication process flow, the two or more goals being based at least in part on data stored within a data platform that is separate from the communication process flow.

Aspect 10: The method of aspect 9, further comprising: routing the plurality of users via one or more paths of the plurality of paths of the communication process flow based at least in part on a result of the one or more paths satisfying at least one goal of the two or more goals, the one or more paths being associated with one or more respective combinations of the plurality of combinations of the at least two first action variations and the at least two second action variations.

Aspect 11: The method of aspect 10, wherein the plurality of users are routed via the one or more paths of the plurality of paths based at least in part on the at least one goal of the two or more goals being satisfied a threshold quantity of times.

Aspect 12: The method of any of aspects 1 through 11, further comprising: generating, via a machine learning model, at least one first action variation of the first action of the plurality of actions in addition to the at least two first action variations and at least one second action variation of the second action of the plurality of actions in addition to the at least two second action variations.

Aspect 13: The method of aspect 12, wherein the at least one first action variation and the at least one second action variation are generated based at least in part on receiving the one or more user inputs.

Aspect 14: The method of any of aspects 1 through 13, wherein the first action of the plurality of actions is an email action and the second action of the plurality of actions is a wait duration action.

Aspect 15: The method of any of aspects 1 through 14, further comprising: displaying, via a first user interface, a variation creation selection component, wherein the one or more user inputs are received via the variation creation selection component.

Aspect 16: An apparatus for data processing, comprising one or more memories storing processor-executable code, and one or more processors coupled with the one or more memories and individually or collectively operable to execute the code to cause the apparatus to perform a method of any of aspects 1 through 15.

Aspect 17: An apparatus for data processing, comprising at least one means for performing a method of any of aspects 1 through 15.

Aspect 18: A non-transitory computer-readable medium storing code for data processing, the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving an indication of a creation of a communication process flow, the communication process flow comprising a plurality of actions that control electronic communications between an entity and a plurality of users;
receiving one or more user inputs that indicates at least two first action variations of a first action of the plurality of actions and at least two second action variations of a second action of the plurality of actions;
generating, based at least in part on receiving the indication of the at least two first action variations and the at least two second action variations, the communication process flow comprising a plurality of paths for a plurality of combinations of the at least two first action variations and the at least two second action variations; and
executing, for the plurality of users, the communication process flow comprising the plurality of paths.

2. The method of claim 1, wherein a respective path for each action variation combination comprises a respective combination of the plurality of combinations of the at least two first action variations and the at least two second action variations.

3. The method of claim 1, wherein generating the communication process flow comprises:
generating the plurality of paths of using each possible combination of the at least two first action variations and the at least two second action variations based at least in part on receiving the one or more user inputs.

4. The method of claim 1, further comprising:
monitoring the communication process flow based at least in part on executing the communication process flow for the plurality of users; and
obtaining a plurality of performance metrics for the plurality of paths of the communication process flow, a respective performance metric for a respective path of the plurality of paths being associated with a respective combination of the at least two first action variations and the at least two second action variations of the plurality of combinations, wherein the plurality of performance metrics are obtained based at least in part on monitoring the communication process flow.

5. The method of claim 4, further comprising:
receiving a second user input that indicates a duration of time for monitoring the communication process flow, wherein the communication process flow is monitored for the duration of time based at least in part on receiving the second user input.

6. The method of claim 4, further comprising:
routing the plurality of users via one or more paths of the plurality of paths of the communication process flow based at least in part on a respective performance metric of the one or more paths, the one or more paths being associated with one or more respective combinations of the plurality of combinations of the at least two first action variations and the at least two second action variations.

7. The method of claim 6, wherein routing the plurality of users via the one or more paths comprises:
routing the plurality of users via the one or more paths based at least in part on the respective performance metric of the one or more paths satisfying a performance metric threshold.

8. The method of claim 4, wherein the plurality of performance metrics indicate user engagement metrics.

9. The method of claim 1, further comprising:
receiving one or more second user inputs that indicate at least two third action variations of a third action of the plurality of actions, the at least two third action variations corresponding to two or more goals for the plurality of paths of the communication process flow, the two or more goals being based at least in part on data stored within a data platform that is separate from the communication process flow.

10. The method of claim 9, further comprising:
routing the plurality of users via one or more paths of the plurality of paths of the communication process flow based at least in part on a result of the one or more paths satisfying at least one goal of the two or more goals, the one or more paths being associated with one or more respective combinations of the plurality of combinations of the at least two first action variations and the at least two second action variations.

11. The method of claim 10, wherein the plurality of users are routed via the one or more paths of the plurality of paths based at least in part on the at least one goal of the two or more goals being satisfied a threshold quantity of times.

12. The method of claim 1, further comprising:
generating, via a machine learning model, at least one first action variation of the first action of the plurality of actions in addition to the at least two first action variations and at least one second action variation of the second action of the plurality of actions in addition to the at least two second action variations.

13. The method of claim 12, wherein the at least one first action variation and the at least one second action variation are generated based at least in part on receiving the one or more user inputs.

14. The method of claim 1, wherein the first action of the plurality of actions is an email action and the second action of the plurality of actions is a wait duration action.

15. The method of claim 1, further comprising:
displaying, via a first user interface, a variation creation selection component, wherein the one or more user inputs are received via the variation creation selection component.

16. An apparatus for data processing, comprising:
one or more memories storing processor-executable code; and
one or more processors coupled with the one or more memories and individually or collectively operable to execute the code to cause the apparatus to:
receive an indication of a creation of a communication process flow, the communication process flow comprising a plurality of actions that control electronic communications between an entity and a plurality of users;
receive one or more user inputs that indicates at least two first action variations of a first action of the plurality of actions and at least two second action variations of a second action of the plurality of actions;
generate, based at least in part on receiving the indication of the at least two first action variations and the at least two second action variations, the communication process flow comprising a plurality of paths for a plurality of combinations of the at least two first action variations and the at least two second action variations; and
execute, for the plurality of users, the communication process flow comprising the plurality of paths.

17. The apparatus of claim 16, wherein a respective path for each action variation combination comprises a respective combination of the plurality of combinations of the at least two first action variations and the at least two second action variations.

18. The apparatus of claim 16, wherein, to generate the communication process flow, the one or more processors are individually or collectively operable to execute the code to cause the apparatus to:
generate the plurality of paths of using each possible combination of the at least two first action variations and the at least two second action variations based at least in part on receiving the one or more user inputs.

19. A non-transitory computer-readable medium storing code for data processing, the code comprising instructions executable by one or more processors to:
receive an indication of a creation of a communication process flow, the communication process flow comprising a plurality of actions that control electronic communications between an entity and a plurality of users;
receive one or more user inputs that indicates at least two first action variations of a first action of the plurality of actions and at least two second action variations of a second action of the plurality of actions;
generate, based at least in part on receiving the indication of the at least two first action variations and the at least two second action variations, the communication process flow comprising a plurality of paths for a plurality of combinations of the at least two first action variations and the at least two second action variations; and
execute, for the plurality of users, the communication process flow comprising the plurality of paths.

20. The non-transitory computer-readable medium of claim 19, wherein the instructions to generate the communication process flow are executable by the one or more processors to:
generate the plurality of paths of using each possible combination of the at least two first action variations and the at least two second action variations based at least in part on receiving the one or more user inputs.
